(19) United States
(12) Patent Application Publication
(10) Pub. No.: US 2013/0325662 A1
(43) Pub. Date: Dec. 5, 2013

(54) SYSTEMS AND METHODS FOR PROVIDING WIRELESS INTERNET CONNECTION

(71) Applicants: Ondrej Zizka, Brno (CZ); Peter Skopek, Myjava (SK)

(72) Inventors: Ondrej Zizka, Brno (CZ); Peter Skopek, Myjava (SK)

(73) Assignee: Red Hat, Inc., Raleigh, NC (US)

(21) Appl. No.: 13/485,660

(22) Filed: May 31, 2012

(51) Int. Cl. G06Q 30/06

(52) U.S. Cl. 705/26.41

(57) ABSTRACT

A mechanism for providing wireless internet connection is disclosed. A method includes receiving, by an internet service provider (ISP) server device from a client device, a request for access to a wireless internet connection from the client device. The request includes a start time for the access, a total time period for the access, and a client identification (ID) of the client device. The method also includes generating a proposed response including price information based on the request and a plurality of payment service providers (PSPs). The method also includes receiving one of an acceptance or denial of the proposed response. The method also includes providing to the selected PSP, the proposed acceptance response, and an ISP ID assigned to the ISP server device. The method further includes sending one of an access or denial of the wireless internet connection to the client device.

### TECHNICAL FIELD

The embodiments of the invention relate generally to a computer system and, more specifically, relate to systems and methods for providing wireless internet connection.

### BACKGROUND

Wireless network technology is commonly known to provide data, including data provided from high-speed internet connections, wirelessly over a computer network to many electronic devices. As known in the art, Wi-Fi is the most popular and commonly used wireless network technology.

Currently, in order to be connected to Wi-Fi, a user of an electronic device requests an internet connection from an internet service provider (ISP) providing the internet connection for that location, pays for the internet connection, and receives a password from the ISP in order to access the internet connection. As such, the user may be communicating individually (via the electronic device) with many different ISPs depending on the locations at which he/she wishes to obtain internet connections. In addition, the user is paying for access to the internet connections at each location the user accesses any of the internet connections.

For each of these communications, a network connection, e.g., request/response, is established between the client and the ISP. This connection generally uses transmission control protocol (TCP) to create a path through the network between the electronic device and the ISP. Hence, for every request from the user to the ISP for the internet connection, a new TCP connection should be established. This operation is expensive for network hardware (e.g. switches and routers) and takes a relatively long time. Also, TCP generally does not provide a very secure and reliable path. Furthermore, the user is charged by the ISP every time the electronic device wishes to access the internet connection.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of a computer system in which the embodiments of the present invention may operate;

FIG. 2 illustrates an example of interactions between a client, an internet service provider server, and a payment agency server in accordance with some embodiments;

FIG. 3 is a flow diagram of one embodiment of an internet service provider server-side method for providing wireless internet connection;

FIG. 4 illustrates a flow diagram of one embodiment of a payment service provider server-side method for providing payment for wireless internet connection; and

FIG. 5 illustrates a flow diagram of one embodiment of a client-side method for obtaining wireless internet connection from wireless internet service provider; and

FIG. 6 illustrates a block diagram of one embodiment of a computer system.

### DETAILED DESCRIPTION

Embodiments of the invention provide for systems and methods for providing wireless internet connection. A method of embodiments of the invention includes receiving, by an internet service provider (ISP) server device from a client device, a request for access to a wireless internet connection from the client device. The request includes a start time for the access, a total time period for the access, and client identification (ID) of the client device. The method also includes generating, by the ISP server device, a proposed response. The proposed response includes price information based on the request and a plurality of payment service providers (PSPs). The method also includes receiving, by the ISP server device, one of an acceptance or denial of the proposed response. The acceptance comprising approval of one of the price information or a selected ISP among the plurality of the PSPs. The method also includes providing, by the ISP server device to the selected PSP, the proposed acceptance response, and an ISP ID assigned to the ISP server device. The method further includes sending, by the ISP server device, one of an access or denial of the wireless internet connection to the client device.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “generating”, “providing”, “selecting”, “forwarding”, “storing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

Embodiments of the invention disclose systems and methods for providing a wireless internet connection. In one embodiment, a connection module may reside on an internet service provider (ISP) server and may receive a request from a client for access to a wireless internet connection. The connection module also receives a client ID of the client. The connection module functions to generate a proposed response which includes price information based on the request and a plurality of payment service provider(s). The connection module also functions to receive one of an acceptance or denial of the proposed response. The acceptance includes approval of one of the price information or a selected ISP among the plurality of the PSPs. The connection module also functions to provide to the selected PSP, the proposed acceptance response, and an ISP ID assigned to the ISP server device. The connection module further functions to send one of an access or denial of the wireless internet connection to the client device.

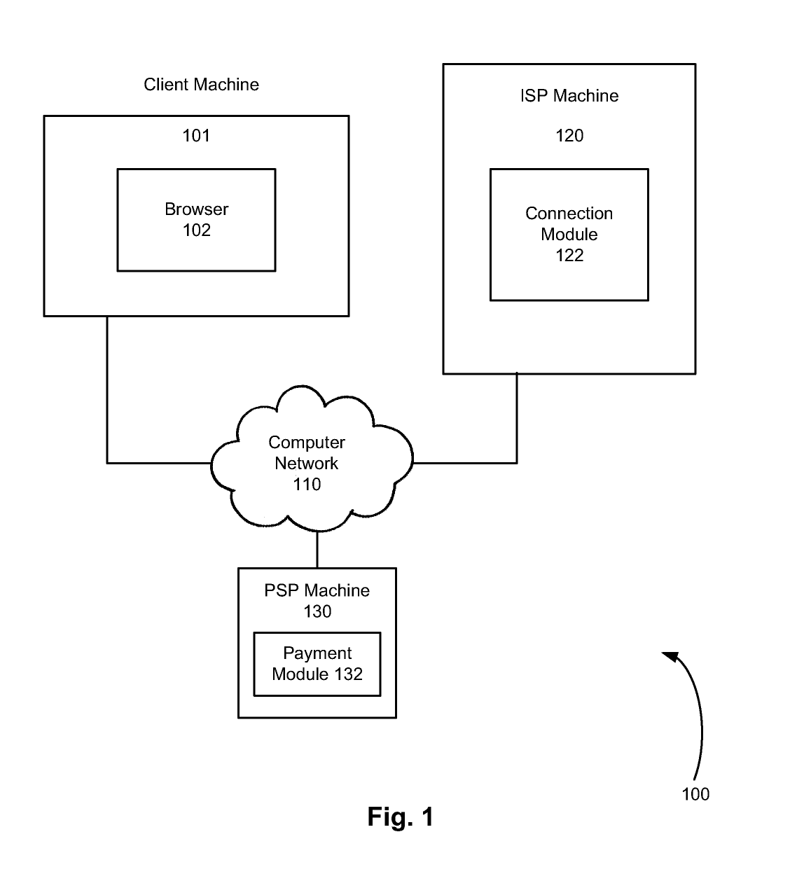

FIG. 1 is a block diagram that illustrates an embodiment of a network architecture 100 in which the embodiments of the present application may operate. Network architecture 100 includes a client machine 101, an internet service provider (ISP) server machine (a.k.a. ISP machine) 120 and a payment service provider (PSP) server (a.k.a. PSP machine) 130. The client machine 101 may be any type of computing device including a laptop computer, a handheld computer, a netbook, a desktop, a workstation, a mobile device such as smart phone, or any other type of computing device. Network architecture 100 may include any number of client devices 101 that communicate over a network 110 with any number of ISP machines 120. Further, network architecture 100 may include any number of PSP machines 130 that also communicate over the network 110 with any number of ISP machines 120.

A single client machine 101, a single ISP machine 120, and a single PSP machine 130 are illustrated and described for sake of clarity, but one skilled in the art will appreciate that embodiments of the invention are not limited to such a depiction. The network 110 may be any type of communication network including, but not limited to, a local area network (LAN), a wide area network (WAN) (e.g., the Internet,) or similar communications network. The communication network 110 can include any number of network devices and computing devices that are in communication over any combination of wired and wireless communication channels.

In one embodiment, the client machine 101 executes a set of applications. A ‘set,’ as used herein refers to any positive whole number of items including a single item. The applications may be any computer-executable program capable of communicating with a web server of the ISP machine 120. In one embodiment, a user (not shown) of the client machine 101 accesses a wireless internet connection to enable the communication from applications to the web server. One example of an application executed by client machine 101 is a browser application 102. In one embodiment, the browser 102 is a web browser.

As part of accessing a wireless internet connection, the browser 102 may search for a plurality of available ISP machines 120 in order to select an available ISP machine 120 from that plurality of ISP machines 120. In one embodiment, the browser 102 selects one or more available ISP machines 120 based on parameters such as signal strength, connection speed, monetary pricing, preferences of the user, etc. The browser 102 sends a request to the selected ISP machine 120. In one embodiment, the request includes, but is not limited to, access to an internet connection at a specific time, a total time period required for the access, and a client ID.

In one embodiment, the client ID is an public cryptography key that is part of an asymmetric cryptography key pair. Each user must have a pair of asymmetric cryptographic keys, which include a public key, and a private key. The public key is widely distributed, while the private key is known only to the recipient and not distributed. Messages may be encrypted with the recipient's public key and sender's private key and decrypted only with the sender's public key and receiver's private key, thus using two separate key pairs. In one embodiment, the public key for the client machine 101 is identified as K_{c1}.

Asymmetric cryptographic keys are used in cryptography for authentication and content verification. Asymmetric cryptographic keys can be binary data of a predefined length, for example 2 kilobytes. In one embodiment, to make identification of the asymmetric cryptographic keys easier for humans, a subset of the binary data, known as a fingerprint, can be extracted. For example, 16 bytes may be extracted as a fingerprint of a 2 kilobyte number. The subset of the binary data of an asymmetric cryptographic key can still be considered unique.

In one embodiment, ISP machine 120 may any type of computing device including a server device, a plurality of server devices, or similar computing device. The network architecture 100 may include any number of ISP machines 120 that communicate over a network 110 with any number of client machines 101. The ISP is an organization that provides access to the Internet. In one embodiment, the ISP provides access to wireless internet connection to the client. Some of the ISPs include but not limited to Comcast, Verizon, AT&T among others. A single ISP machine 120 is illustrated and described for sake of clarity. In one embodiment, the ISP machine 120 hosts a connection module 122 that receives a request from the client machine 101. In one embodiment, the request includes, but is not limited to, access to an internet connection at a specific time, a total time period required for the access, and a client ID of the client machine.

In response to the request, the connection module 122 generates price information based on the request. In one embodiment, the price information includes total cost to the user for the client machine 101 to access the internet via the ISP 120. The connection module 122 then searches for a plurality of PSP machines 130 to render a set of PSP machines 130. In one embodiment, PSP machines 130 are rendered based on one or more conditions, such as type of service contract between the ISP and the PSPs and contract between the client and a specific PSP. In one embodiment, the service contract includes ability of the ISP to receive payment from the PSP. In one embodiment, the contract between the client and the specific PSP includes but is not limited to PSP already having some credit from a given client and the PSP is able to retrieve money from the client via various means.

In one embodiment, the PSP offers clients online services for accepting electronic payments by a variety of payment methods including but not limited to credit card, bank-based payments such as direct debit, bank transfer, and real-time bank transfer based on online banking. Some PSPs provide services to process other next generation methods (Payment systems) including but not limited to cash payments, prepaid cards or vouchers, and even paper or e-check processing. Some of the PSPs include but not limited to PayPal, WebMoney, Amazon Payments, HSBC etc. In one embodiment, the PSPs include account information of the client and based on the client information will authorize the ISP to provide wireless internet connection to the client on various places. Some of these places include but not limited to airports, coffee shops, restaurants, parks etc.

The connection module 122 sends a proposed response including the price information, the set of PSPs machines 130 and an ISP ID associated with the originating ISP machine 120 to the client machine 101. In one embodiment, the ISP ID is an public key as described above. In one embodiment, a public key for the ISP machine 120 is K_{N}.

In one embodiment, upon receipt of the proposed response, the client machine 101 sends a denial proposed response to the connection module 122 of the selected ISP machine 120. In one embodiment, the denial proposed respone includes but not limited to disapproval of the price information and/or not selecting the PSP from the set of PSPs. In one embodiment, upon receipt of the denial proposed response, the connection module 122 of the ISP machine 120 may generate another price information and/or another set of PSPs to send to the client machine 101.

In another embodiment, upon receipt of the proposed response, the client machine 101 accepts the price information and selects the PSP from the set of PSPs. In one embodiment, the user of the client machine 101 selects from the set of PSPs based on the one or more conditions described above. The client machine 101 sends an acceptance of the proposed response 205 including acceptance of the price information and the selected PSP to the ISP machine 120. Upon receipt of the approval of the proposed response from the client machine 101, the ISP machine 120 and generates a message including the proposed acceptance response, the request and the ISP ID to the selected PSP machine 130.

A PSP machine 130 can be any type of computing device including a server device, a plurality of server devices, or similar computing device. The network architecture 100 may include any number of PSP machines 130 that communicate over the network 110 with any number of ISP machines 120. A single PSP machine 130 is illustrated and described for sake of clarity. In one embodiment, the PSP machine 130 is the PSP selected by the client.

In one embodiment, the PSP machine 130 hosts a payment module 132 that receives the message and the ISP ID of the sending ISP machine 120. The payment module 132 reviews account information of the user of the client machine 101 based on the received request and the price information, and then determines whether a transaction can occur between the client machine 101 and the ISP machine 120.

In one embodiment, if the payment module 132 determines that the transaction can occur between the client machine 101 and the ISP machine 120, then the payment module 132 generates an acceptance response. In one embodiment, the acceptance response includes an approval of the transaction between the client machine 101 and the ISP machine 120, a transactional ID, the original request of the client machine 101 and the price information. In one embodiment, the transactional ID includes a unique identifier to identify the transaction. The payment module 132 then sends the acceptance response along with a PSP ID of the PSP machine 130, to the ISP machine 120. In one embodiment, the PSP ID of the PSP machine 130 is a public key as described above. In one embodiment, a public key for the PSP machine 130 is K_{A1}.

In another embodiment, the payment module 132 determines that the transaction cannot occur between the client 101 and the ISP machine 120 and generates a denial response. In one embodiment, the denial response includes a denial message of the transaction between the client machine 101 and the ISP machine 120, the original request of the client machine's 101, and the price information. In some embodiments, the denial response includes reasons for the denial of the transaction. The reasons for denial include, but are not limited to insufficient funds in the client's account, the credit card provided in the client's account is expired or soon to be expired, client failed to fulfill some conditions of the PSP and compromise in client's key pair. The payment module 132 sends the denial response, along with the PSP ID of the PSP machine 130, to the ISP machine 120. In one embodiment, the PSP ID of the PSP machine 130 is an asymmetric cryptography key as described above. In one embodiment, a public key for the PSP machine 130 is K_{A1}.

In some embodiments, the connection module 122 of ISP machine 120 receives the acceptance response and the forwards the acceptance response to the client machine 101. The browser 102 of the client machine 101 then sends the acceptance response back to the ISP machine 120, signed with client's private key. In one embodiment, the signature indicates that user of the client machine 101 accepts the price information. The connection module 122 of ISP machine 120 may then forward the acceptance response and additionaly signed with ISP private key along with the ISP ID of the ISP machine 120 to the PSP machine 130.

Upon receipt of the acceptance response and the signed, keys of the client and the ISP, the payment module 132 of the PSP machine 130 approves the transaction between the ISP machine 120 and the client machine 101. In one embodiment, the approval of the transaction includes the PSP machine 130 approving for the ISP machine 120 to provide the client machine 101 with access to the wireless internet connection. The PSP machine 130 also generates a notification indicating approval of the transaction to the ISP machine 120. The payment module 132 of the PSP machine 130 forwards the notification along with the PSP ID of the PSP machine 130 to the ISP machine 120. In one embodiment, upon receipt of the notification, the connection module 122 of the ISP machine 120 provides access to the internet connection to the client machine 101. In some embodiments, the PSP will pay the ISP on behalf of the client during, or after or even before the client accesses the wireless internet connection.

In another embodiment, the connection module 122 of the ISP machine 120 receives the denial response and forwards the denial response to the client machine 101. Upon receipt of the denial response, the browser 102 of the client machine 101 may elect to choose another available ISP machine 120 and send the original request of the client machine 101 to this other available ISP machine 120. In another embodiment, the browser 102 of the client machine 101 may elect to choose to edit the original request of the client machine 101. The browser 102 of the client machine 101 may then send this edited request to the selected ISP machine 120. In a further embodiment, the browser 102 of the client machine 101 may elect to send the edited request to the other available ISP machine.

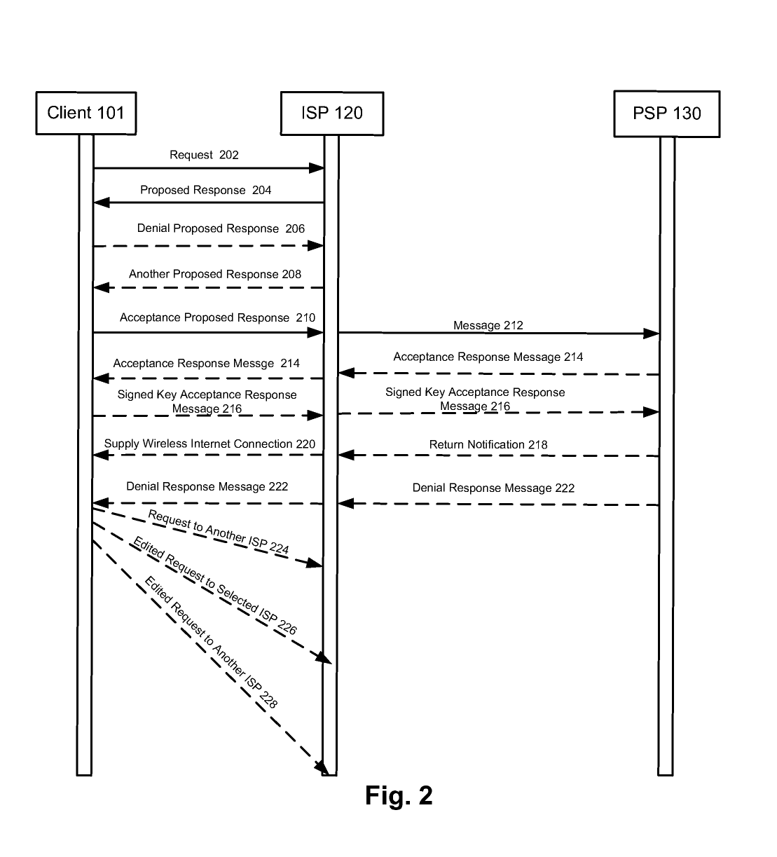

FIG. 2 is a communication flow diagram depicting interactions between a client machine 101, an ISP machine 120, and a PSP machine 130 according to an embodiment of the invention. In one embodiment, client machine 101, ISP machine 120, and PSP machine 130 are the same machines as described with respect to FIG. 1. As shown, a request 202 for wireless internet connection, along with a client ID of the client machine 101, is submitted by the client machine 101 to a selected ISP machine 120. The ISP machine 120 generates price information based on the request and appends a set of possible PSPs and sends a proposed response 204 including the price information and the set of possible PSPs to the client.

In one embodiment, upon receipt of the proposed response, the client machine 101 sends a denial proposed response 206 to the ISP machine 120. The denial proposed response 206 includes but not limited to disapproving the price information and not selecting from the set of the PSPs. The ISP machine 120 generates another proposed response 208 and sends to the client machine 101. The another proposed response includes but is not limited to another price information and another set of the PSPs.

In another embodiment, upon receipt of the proposed response, a user of the client machine 101 makes a decision on approving the price information and selecting one of the PSPs in the set of the possible PSPs. In one embodiment, the user of the client machine 101 may have a contract with one or more of the set of the PSPs. In one embodiment, the user of the client machine 101 selects the PSP based on the contract. The client machine 101 sends the acceptance proposed response 210 including approving the price information and the selected PSP to the ISP machine 120.

Upon receipt of the acceptance proposed response, the ISP machine then generates and sends a message 212 including the acceptance proposed response, the request and the ISP ID to the PSP machine 130 selected by the client machine 101. In one embodiment, the PSP machine 130 generates and sends 214 an acceptance response message that includes an acceptance of the transaction between the client machine 101 and the ISP machine 120, along with a PSP ID of the PSP machine 130, to the ISP machine 120. The ISP machine 120, in turn, forwards 214, the acceptance response message along with the ISP ID to the client machine 101. The client machine 101 returns 216 the acceptance response message along with a signed key to the ISP machine 120. The ISP machine 120 forwards 216 the signed key acceptance response message along with the ISP ID to the PSP machine 130. The PSP machine 130 generates a notification message and sends 218 the notification message along with the PSP ID to the ISP machine 120. In response, the ISP machine 120 supplies 220 a wireless internet connection to the client machine 101.

In an alternate embodiment, the PSP machine 130 generates and sends 222 a denial response message that includes a denial message along with the PSP ID of the PSP machine 130 to the ISP machine 120. The ISP machine 120, in turn, forwards 222 the denial response message along with the ISP ID to the client machine 101. As discussed above, the client machine 101 may select another available ISP machine 120 and send 224 a request to this other available ISP machine 120. In another embodiment, the client machine 101 may edit the original request and send 226 this edited request to the selected ISP machine 120 or, in some embodiments, to 228 to the other available ISP machine 120.

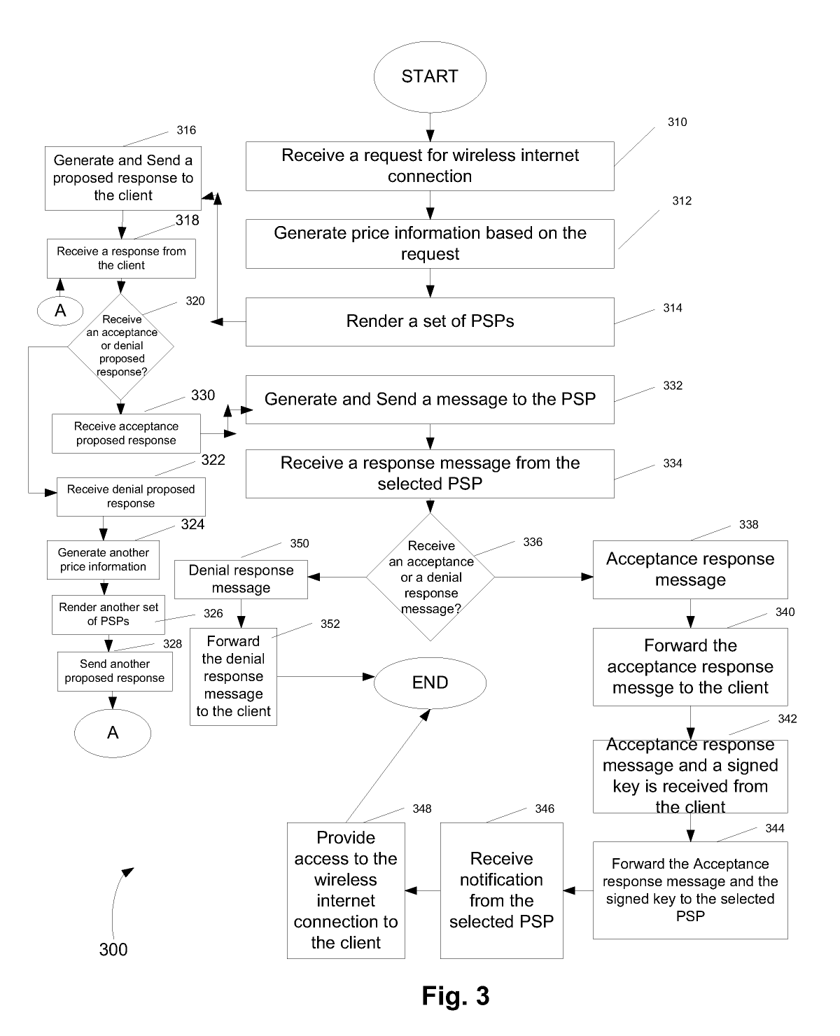

FIG. 3 is a flow diagram illustrating a method 300 for providing wireless internet connection by an ISP server according to an embodiment of the invention. Method 300 may be performed by processing logic that may comprise hardware (e.g., circuitry, dedicated logic, programmable logic, microcode, etc.), software (such as instructions run on a processing device), firmware, or a combination thereof. In one embodiment, method 300 is performed by the connection module 122 of FIG. 1.

Method 300 begins at block 310 where a request for wireless internet connection is received from a client machine. The ISP server receives the request for the wireless internet connection from a user of the client machine. In one embodiment, the request includes, but is not limited to, access to an internet connection at a specific time, a total time period required for the access, and a client ID of the client machine. At block 312, the ISP server generates price information based on the request. The price information may include a total cost to the user for the client machine to access the requested internet connection wirelessly.

At block 314, the ISP server renders a set of PSP machines from a plurality of PSP machines. In one embodiment, the set of PSP machines are rendered based on one or more conditions such as type of service contract between the ISP and the PSP, contract between the client and a specific PSP. In one embodiment, the service contract includes ability of the ISP to receive payment from the PSP. In one embodiment, the contract between the client and the specific PSP includes but is not limited to PSP already having some credit from a given client and the PSP is able to retrieve money from the client via various means.

At block 316, a proposed response is generated and sent to the client machine 101. In one embodiment, the proposed response includes the price information, the set of the PSP machines and an ISP ID of the ISP machine. At block, 318, a response is received back from the client machine. In some embodiments, the response received is one of an acceptance or denial of the proposed response.

In one embodiment, at block 320 it is determined whether the response is an acceptance or denial of the proposed response. At block 322 is determined that the type of response received is a denial proposed response. At block 324, another price information is generated by the ISP server. At block 326, another set of PSPs is renderd by the ISP server. Subsequently, at block 328, another proposed response including the another price information and the another set of PSPs are sent to the client. The method is repeated from block 318 as shown by letter A.

At block 330, it is determined that the type of response is an approval proposed response. Subsequently, at block 332, a message including the client machine request, the generated price information, and the ISP ID of the ISP machine is sent to the selected PSP machine. In one embodiment, the ISP ID is the asymmetric cryptography key as described above. In one embodiment, the ISP ID is an public key as described above. In one embodiment, a public key for the ISP machine is Kₚ₁. The response message is received from the selected PSP machine at block 334. In one embodiment, the response message if one of an acceptance or a denial response message is received from the PSP machine. At block 336, it is determined whether the type of the received response message is an acceptance response or a denial response.

In one embodiment, at block 338, it is determined that the type of response message is an acceptance response message. In one embodiment, the acceptance response message includes an approval of the transaction between the client machine and the ISP server, the original client machine request, the price information, and a transactional ID. At block 340, the acceptance response message is forwarded to the client machine. At block 342, the acceptance response message including a signed key K_{c1} is received at the ISP server from the client machine. In one embodiment, the signature indicates that user of the client machine accepts the price information.

Then, at block 344, the acceptance response message with the signed key of the client machine along with the ISP ID of the ISP server is forwarded to the selected PSP machine. At block 346, a notification is received at the ISP server from the PSP machine. In one embodiment, the notification indicates approval of a transaction between the client machine and the selected ISP machine. At block 348, the ISP server provides access to the wireless internet connection to the client machine.

In another embodiment, at block 350, it is determined that the type of response message is a denial response message. At block 352, the denial response message is forwarded to the client machine 101.

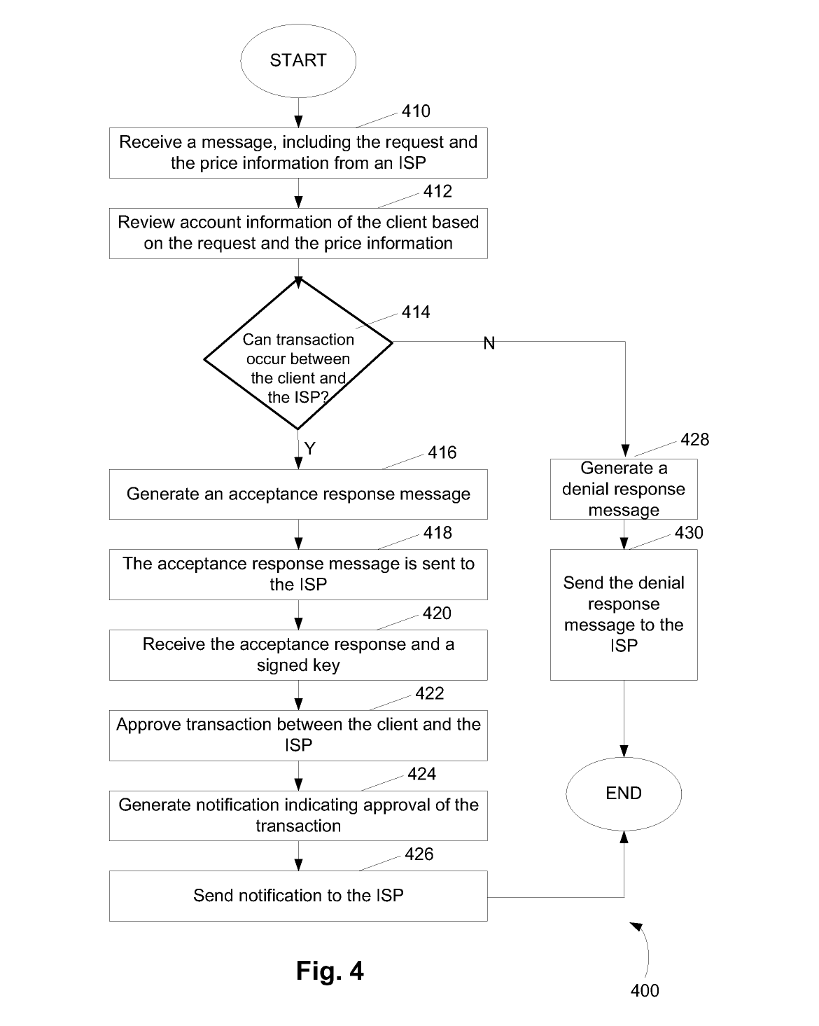

FIG. 4 is a flow diagram illustrating a method 400 for providing wireless internet connection performed by a PSP server according to an embodiment of the invention. Method 400 may be performed by processing logic that may comprise hardware (e.g., circuitry, dedicated logic, programmable logic, microcode, etc.), software (such as instructions run on a processing device), firmware, or a combination thereof. In one embodiment, method 400 is performed by the payment module 132 of FIG. 1.

Method 400 begins at block 410 where the PSP server receives a message including a client machine request to access a wireless internet connection, price information generated by an ISP server detailing costs for the client machine to access the internet connection, and an ISP ID of the ISP machine sending the message. At block 412, the account information of a user of the client machine is reviewed based on the request and the price information. At block 414, it is determined whether a transaction can occur between the client machine and the ISP machine.

If, at block 414, it is determined that the transaction can occur, then at block 416 an acceptance response is generated at block 416. In one embodiment, the acceptance response includes an approval of the transaction between the client machine and the ISP machine, a transactional ID, the original client machine request, and the ISP server-generated price information. In one embodiment, the transactional ID includes a unique identifier to identify the transaction. At block 418, the acceptance response along with a PSP ID of the PSP machine is sent to the ISP machine. In one embodiment, the PSP ID of the PSP machine is a public key as described above. In one embodiment, a public key for the PSP machine is K_{A1}.

At block 420, the PSP server receives the acceptance response with the signed key of the client machine along with the PSP ID of the PSP machine. At block 422, a transaction is approved between the ISP machine and the client machine. In one embodiment, the approval of the transaction includes the PSP server approving for the ISP machine 120 to provide the client machine 101 with access to the wireles internet connection. At block 424, a notification indicating approval of the transaction is generated. At block 426, the notification along with the PSP ID of the PSP machine is sent to the ISP machine.

If at block 414, it is determined that the transaction cannot occur between the client and the ISP machine, a denial response is generated at block 428. In one embodiment, the denial response includes a denial of the transaction between the client machine and the ISP machine, the original client machine request, and the price information. In some embodiments, the denial response includes reasons for the denial of the transaction. At block 430, the denial response, along with the PSP ID of the PSP machine is sent to the ISP machine.

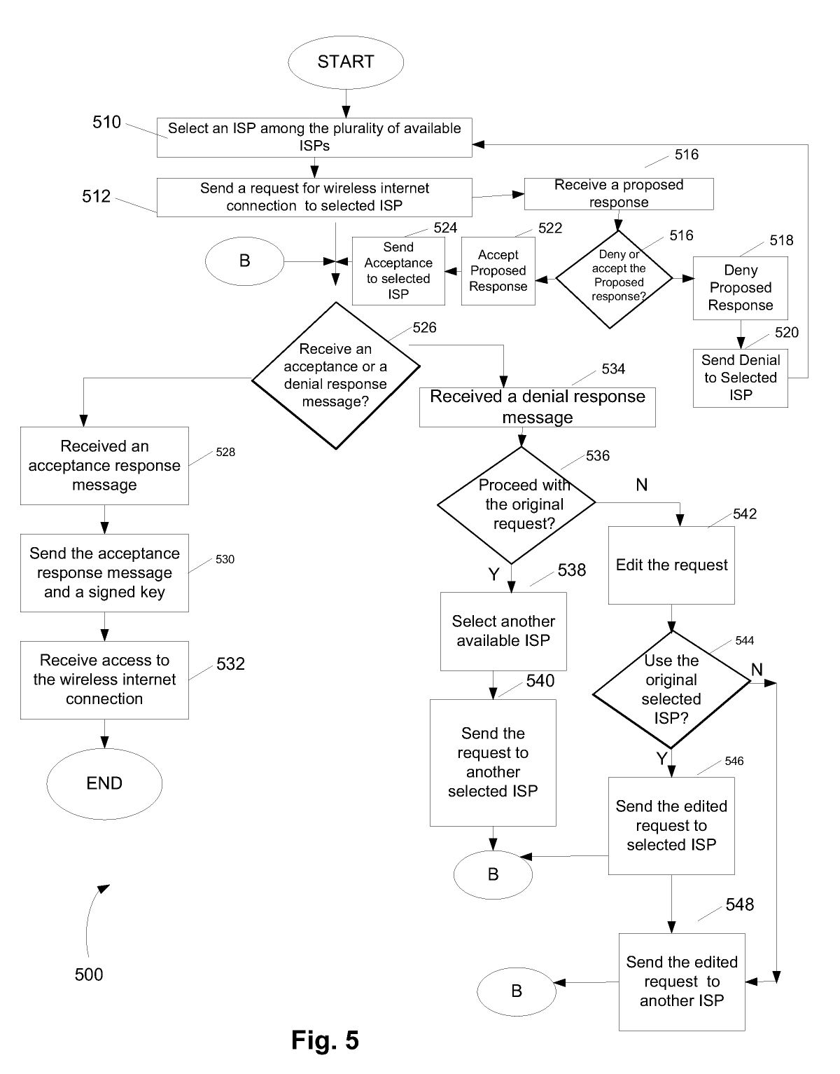

FIG. 5 is a flow diagram of a method 500 for wireless internet connection performed by a client machine according to an embodiment of the invention. Method 500 may be performed by processing logic that may comprise hardware (e.g., circuitry, dedicated logic, programmable logic, microcode, etc.), software (such as instructions run on a processing device), firmware, or a combination thereof. In one embodiment, method 500 is performed by a browser 102 of FIG. 1.

At block 510, an ISP machine is selected among plurality of available ISP machines are searched by the browser. In one embodiment, the ISP machines is selected by the browser based on parameters such as signal strength, connection speed, lowest price, client's preferences, and so on. At block 512, the browser sends a request to access wireless internet connection to the selected ISP machine. The request includes, but is not limited to, an internet connection at a specific time, a total time period required for the access, and a client ID of the client machine. In one embodiment, the client ID is an public key as described above. In one embodiment, a public key for the client machine is K_{c1}.

At block 514, a proposed response is received from the selected ISP machine. In one embodiment, the proposed response includes the price information, the set of the PSP machines and an ISP ID of the ISP machine. At block, 516, it is determined whether to deny or accept the proposed response. In one embodiment, at block 518 it is determined to deny the proposed response. In one embodiment, the client machine 101 disapproves the price information and/or does not select the PSP from the set of PSPs. At block 520, the denial proposed response is sent to the selected ISP machine. The process is repeated at block 510.

In another embodiment, at block 522, it is determined to accept the proposed response. At block 524, the acceptance proposed response is sent to the selected ISP machine. In one embodiment, the acceptance proposed response includes request, the generated price information and the client ID. At block 526, it is determined whether an acceptance or a denial response message is received from the selected ISP. At block 528, it is determined that an acceptance response message is received from the selected ISP machine. In one embodiment, the acceptance response message includes an approval of the transaction between the client machine and the ISP machine, a transactional ID, the original client machine request, and the price information generated by the ISP machine detailing costs associated with accessing the internet connection. At block 530 the acceptance response message along with a signed key K_{c1} of the client machine is sent by the browser. At block 532 the browser receives access to the wireless internet connection.

In another embodiment, at block 534, a denial response message is received from the ISP machine. In one embodiment, the denial response message includes a denial of the transaction between the client machine and the ISP machine, the original client machine request, and the price information. In some embodiments, the denial response message also includes reasons for the denial of the transaction. These reasons may include, but are not limited to, insufficient funds in the client's account, the credit card provided in the client's account is expired or soon to be expired, client failed to fulfill some conditions of the PSP and compromise in client's key pair.

In one embodiment, at block 536 a decision is made whether to proceed with the original request. At block 538, another available ISP machine is selected by the browser if at block 536 the decision is made to proceed with the original request. At block 540, the request is sent to this other available ISP machine. The method is repeated from block 526 as show by letter B. In another embodiment, at block 542 the request is edited by the browser if at block 536 the decision is made not to proceed with the original request. In a further embodiment, at block 544, a decision is made whether to send the edited request to the original selected ISP machine. At block 546 the edited request is sent by the browser to the selected ISP machine if at block 544 the decision is made to send the edited request to the original selected ISP machine. The method is repeated from block 526 as show by letter B. At block 548, the edited request is sent by the browser to the other available ISP machine if at block 546 the decision is made not to send the edited request to the original selected ISP machine. The method is repeated from block 526 as shown by letter B.

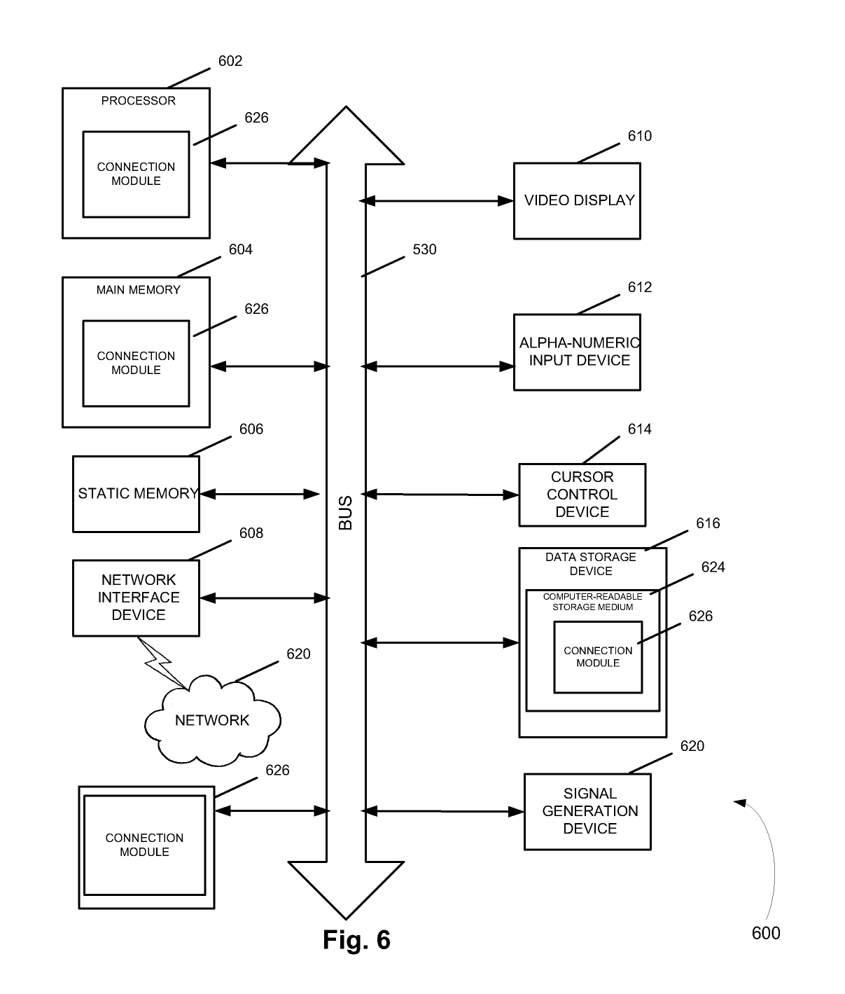

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute connection module logic 626 including the connection module 122 of FIG. 1 for performing the operations and steps discussed herein.

The computer system 600 may further include a network interface device 508. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 516 (e.g., a speaker).

The data storage device 618 may include a machine-accessible storage medium (or more specifically a computer-readable storage medium) 624 on which is stored one or more sets of instructions (e.g. connection module logic 626) embodying any one or more of the methodologies of functions described herein (e.g. connection module 122 of FIG. 1). The connection module logic 626 may also reside, completely or at least partially, within the main memory 604 and/or within the processing device 602 during execution thereof by the computer system 600; the main memory 604 and the processing device 602 also constituting machine-accessible storage media.

The machine-readable storage medium 624 may also be used to store the connection module logic 626 persistently. While the machine-accessible storage medium 624 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A method comprising:
receiving, by a service provider (SP) server device from a client device, a request for access to a wireless connection;
generating, by the SP server device, a proposed response, wherein the proposed response comprises price information in view of the request and a plurality of payment service providers (PSPs);
receiving, by the SP server device, an acceptance of the proposed response, wherein the acceptance comprises approval of the price information and selection of a PSP among the plurality of the PSPs; and
providing, to the client device, by the ISP server device, access to the wireless connection in view of the proposed acceptance response.

2. The method of claim 1 further comprising receiving a PSP ID and a response from the selected PSP, the PSP ID is assigned to the selected PSP and the response comprises an acceptance response to the proposed acceptance response.

3. The method of claim 2 further comprising forwarding the acceptance response and the PSP ID to the client device, the acceptance response comprises an approval of a transaction between the client device and the selected PSP and the price information.

4. The method of claim 3 further comprising receiving a signed acceptance response and a client identification (ID) of the client device from the client device, the signed acceptance response comprise acceptance of the price information by the client device.

5. The method of claim 4 further comprising forwarding the signed acceptance response and an SP ID of the SP server device to the selected PSP.

6. The method of claim 5 further comprising receiving a notification and the PSP ID from the selected PSP, the notification comprise approval of transaction between the client device and the SP server device.

7. The method of claim 6 further comprising providing access to the wireless connection to the client device.

8. The method of claim 6, wherein the client ID comprises a first public key and the SP ID comprises a second public key and the PSP ID comprise a third public key.

9. The method of claim 2 further comprising forwarding a denial response and the PSP ID to the client device, the denial response is received from the selected PSP and comprises a disapproval of a transaction between the client device and the PSP and the price information.

10. A service provider (SP) server device comprising:
a memory; and
a processing device coupled to the memory to:
receive from a client device, a request for access to a wireless connection;
generate a proposed response, wherein the proposed response comprises price information in view of the request and a plurality of payment service providers (PSPs);
receive, an acceptance of the proposed response, wherein the acceptance comprises approval of the price information and selection of a PSP among the plurality of the PSPs;
and
provide, to the client device an access to the wireless connection in view of the proposed acceptance response.

11. The SP server device of claim 10, wherein the processing device to receive a PSP ID and a response from the selected PSP, the PSP ID is assigned to the selected PSP and the response comprises an acceptance response to the proposed acceptance response.

12. The SP server device of claim 11 wherein the processing device to:
forward the acceptance response and the PSP ID to the client device, the acceptance response comprises an approval of a transaction between the client device and the selected PSP and the price information; and
receive a signed acceptance response and a client identification (ID) of the client device from the client device, the signed acceptance response comprise acceptance of the price information by the client device.

13. The SP server device of claim 12 wherein the processing device to:
forward the signed acceptance response and an SP ID of the SP server device to the selected PSP; receive a notification and the PSP ID from the selected PSP, the notification comprise approval of transaction between the client device and the SP server device; and
provide access to the wireless connection to the client device.

14. The SP server device of claim 11 wherein the processing device to forward a denial response and the PSP ID to the client device, the denial response is received from the selected PSP and comprises a disapproval of a transaction between the client device and the PSP and the price information.

15. The SP server device of claim 11 wherein the client ID comprises a first public key and the SP ID comprises a second public key and the PSP ID comprise a third public key.

16. A non-transitory machine-readable storage medium including data that, when accessed by an service provider (ISP) server device, cause the (SP) server device to perform operations comprising:
receiving, by the SP server device from a client device, a request for access to a wireless connection;
generating, by the SP server device, a proposed response, wherein the proposed response comprises price information in view of the request and a plurality of payment service providers (PSPs);
receiving, by the SP server device, an acceptance of the proposed response, wherein the acceptance comprises approval of the price information and selection of a PSP among the plurality of the PSPs;
and
providing, to the client device, by the SP server device, access to the wireless connection in view of the proposed acceptance response.

17. The non-transitory machine-readable storage medium of claim 16 having further data therein, which accessed by the SP server device, cause the SP server device to perform a further set of operations, further comprising:
receiving a PSP ID and a response from the selected PSP, the PSP ID is assigned to the selected PSP and the response comprises an acceptance response to the proposed acceptance response.

18. The non-transitory machine-readable storage medium of claim 17 having further data therein, which accessed by the SP server device, cause the SP server device to perform a further set of operations, further comprising:
forwarding the acceptance response and the PSP ID to the client device, the acceptance response comprises an approval of a transaction between the client device and the selected PSP and the price information; and
receiving a signed acceptance response a client identification (ID) of the client device from the client device, the signed acceptance response comprise acceptance of the price information by the client device.

19. The non-transitory machine-readable storage medium of claim 18 having further data therein, which accessed by the SP server device, cause the SP server device to perform a further set of operations, further comprising:
forwarding the signed acceptance response and an SP ID of the SP server device to the selected PSP;
receiving a notification and the PSP ID from the selected PSP, the notification comprise approval of transaction between the client device and the SP server device; and
providing access to the wireless connection to the client device.

20. The non-transitory machine-readable storage medium of claim 17 wherein the client ID comprises a first public key and the SP ID comprises a second a public key and the PSP ID comprise a third public key.

21. The method of claim 1 further comprising receiving, by the SP server device, a denial of the proposed response, the denial comprising disapproval of one of the price information or the selected PSP among the plurality of the PSPs.

22. The SP server device of claim 10 wherein the processing device to receive a denial of the proposed response, wherein the denial comprising disapproval of one of the price information or the selected PSP among the plurality of the PSPs.

23. The non-transitory machine-readable storage medium of claim 15 having further data therein, which accessed by the SP server device, cause the SP server device to perform a further set of operations, further comprising:
receiving, by the SP server device, a denial of the proposed response, the denial comprising disapproval of one of the price information or the selected PSP among the plurality of the PSPs.
